(19) United States
(12) Patent Application Publication
(10) Pub. No.: US 2025/0286968 A1
(43) Pub. Date: Sep. 11, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: OKINORI TSUCHIYA, Kanagawa (JP); TATSUHIRO YAMAGATA, Tokyo (JP); TAKASHI FUJITA, Tokyo (JP); HIROMITSU YAMAGUCHI, Kanagawa (JP); AKITOSHI YAMADA, Kanagawa (JP); HIDETSUGU KAGAWA, Kanagawa (JP)

(21) Appl. No.: 19/061,179

(22) Filed: Feb. 24, 2025

(30) Foreign Application Priority Data
Mar. 7, 2024 (JP) 2024-035275

(51) Int. Cl. H04N 1/00

(52) U.S. Cl. CPC H04N 1/00503; H04N 1/00482; H04N 1/00538

(57) ABSTRACT

An image processing apparatus to which a post-processing unit is attachable, a height from a position of a print medium discharged from a sheet discharge port to the sheet discharge port being reduced after the post-processing unit has been attached, the image processing apparatus includes an input unit configured to, after the post-processing unit has been attached, input an instruction for setting a first mode among a plurality of print modes for determining print conditions in printing a print target image and a generation unit configured to, when, after the post-processing unit has been attached, there is a second mode which is different from the first mode and in which an amount of ink used to print a same image is smaller than that in the first mode, generate a display image to indicate that the second mode can be selected as the print mode for the print target image.

### BACKGROUND

### Field of the Disclosure

The present disclosure relates to image processing for a printing apparatus to and from which a post-processing unit is attachable and detachable.

### Description of the Related Art

After printing with a printer in, for example, an office, some post-processing steps may be time-consuming. For example, in the case where printed materials such as meeting materials and proposals are to be distributed, examples of these steps include a step of sorting the printed materials by number of copies and a step of stapling the printed materials together.

Productivity can be improved by disposing a mechanism having a post-processing function in a sheet discharge unit in a printer and causing the mechanism to automatically perform post-processing.

On the other hand, in the case where the mechanism is independent, it requires large space for disposition. Japanese Patent Laid-Open No. 2022-70446 suggests that a post-processing function is added without increasing space as compared with a post-processing mechanism placed side-by-side with respect to a printer by inserting a small post-processing mechanism into a sheet discharge unit in a printer.

However, when the post-processing mechanism is inserted into the sheet discharge unit, a sheet discharge port becomes narrower and a paper jam (hereinafter also referred to as a jam) is more likely to occur.

### SUMMARY

The present disclosure provides an image processing apparatus to which a post-processing unit is attachable, a height from a position of a print medium discharged from a sheet discharge port to the sheet discharge port being reduced after the post-processing unit has been attached, the image processing apparatus includes at least one memory that stores a set of instructions and at least one processor that executes the instructions causing the image processing apparatus to perform operations. The at least one processor includes an input unit configured to, after the post-processing unit has been attached, input an instruction for setting a first mode among a plurality of print modes for determining print conditions in printing a print target image and a generation unit configured to, when, after the post-processing unit has been attached, there is a second mode which is different from the first mode and in which an amount of ink used to print a same image is smaller than that in the first mode, generate a display image to indicate that the second mode can be selected as the print mode for the print target image.

Further features of the present disclosure will become apparent from the following description of exemplary embodiments with reference to the attached drawings.

### BRIEF DESCRIPTION OF THE DRAWINGS

FIG. 1 is a block diagram illustrating the configuration of an image processing apparatus.

FIG. 2 is a block diagram illustrating the flow of image processing.

FIG. 3 is a diagram illustrating in detail a printing apparatus.

FIG. 4A is diagram illustrating a UI for print settings.

FIG. 4B is diagram illustrating a UI for setting a post-processing function.

FIG. 5 is a diagram illustrating the curl of a recording medium.

FIGS. 6A and 6B are schematic diagrams illustrating a curled state.

FIG. 7 is a diagram illustrating a sheet discharge unit to which a post-processing mechanism is attached.

FIGS. 8A and 8B are diagrams illustrating an ink ejection amount and a curl amount.

FIGS. 9A and 9B are diagrams illustrating the relationship between a printing time and a curl amount.

FIG. 10 is a flowchart illustrating a whole process according to a first embodiment and a second embodiment.

FIG. 11 is a diagram illustrating a print operation table.

FIGS. 12A, 12B, and 12C are schematic diagrams illustrating curled states at the time of duplex printing.

FIGS. 13A and 13B are diagrams illustrating examples of UI screens for print settings.

### DESCRIPTION OF THE EMBODIMENTS

Preferred embodiments of the present disclosure will be described in detail below by way of example with reference to the accompanying drawings.

The components described in the following embodiments are merely illustrative, and are not construed as limiting the scope of the present disclosure thereto.

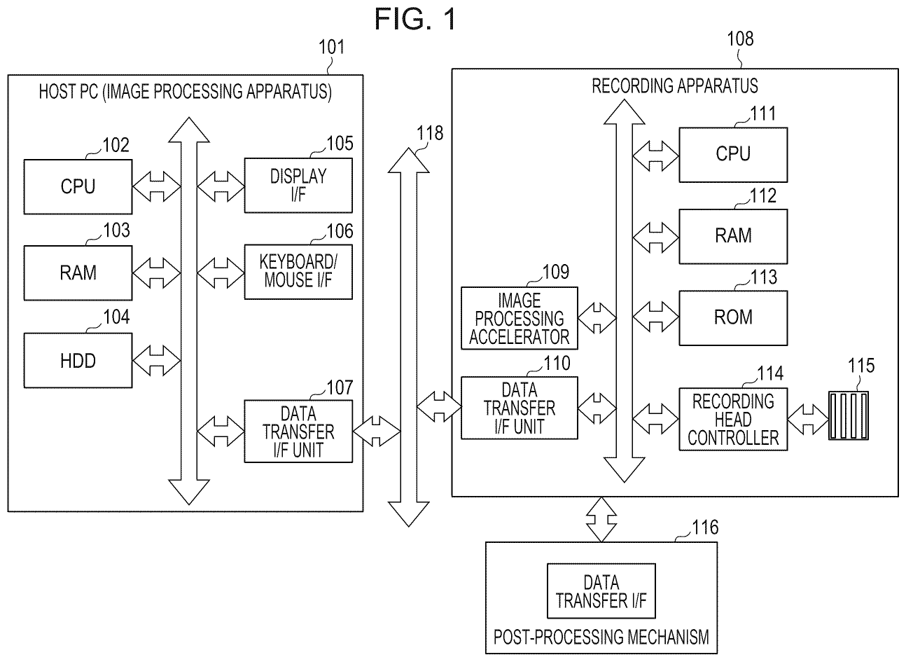

FIG. 1 is a block diagram illustrating the configuration of a printing system. An image processing apparatus 101 is constituted by, for example, a host PC or a tablet PC. A CPU 102 executes various pieces of processing in accordance with programs stored in an HDD 104 while using a RAM 103 as a work area. For example, the CPU 102 generates image data, which is recordable by a printing apparatus (a recording apparatus 108), in accordance with a command received from a keyboard/mouse or touch panel (not illustrated) via a keyboard/mouse I/F 106 or a program stored in the HDD 104 and transfers the generated image data to the recording apparatus 108.

A post-processing mechanism 116 (post-processing unit) is attachable and detachable to and from the recording apparatus 108. Attachable and detachable mean that the post-processing mechanism 116 can be additionally attached to the recording apparatus 108 that can perform printing and a sheet discharge without the post-processing mechanism 116. The post-processing mechanism 116 may be attached after providing space for the attachment thereof by removing a sheet discharge tray and peripheral components used when the post-processing mechanism 116 is not present. That is, the attachment of the post-processing mechanism 116 may be performed not only by adding it without removing the components of the recording apparatus 108 but also by replacing some of the components of the recording apparatus 108. When removing the post-processing mechanism 116, the opposite of what is done when attaching it can be said.

When the post-processing mechanism 116 is attached, it is connected to the recording apparatus 108 and desired post-processing is performed in response to an instruction from a control unit in the recording apparatus 108. Examples of the post-processing include a stapling function for holding a plurality of printed materials together, a punching function, and a shift sort function.

The image processing apparatus 101 performs predetermined processing upon image data received from the recording apparatus 108 via a data transfer I/F 107 in accordance with a program stored in the HDD 104 and displays a result of the processing and various pieces of information on a display (not illustrated) via a display I/F 105.

In the recording apparatus 108, a CPU 111 performs various pieces of processing in accordance with programs stored in a ROM 113 while using a RAM 112 as a work area. The recording apparatus 108 further includes an image processing accelerator 109 for high-speed image processing. The image processing accelerator 109 is a piece of hardware capable of performing image processing at a higher speed than the CPU 111. The image processing accelerator 109 is started by the CPU 111 writing a parameter and data necessary for image processing to a predetermined address in the RAM 112, reads the parameter and the data, and performs predetermined image processing upon the data. From the above, the recording apparatus 108 can also be said to be an image processing apparatus. In that case, the image processing apparatus is included in the recording apparatus 108 and becomes part of the recording apparatus 108. The CPU 111 and the image processing accelerator 109 perform central control of the image processing apparatus in the recording apparatus 108. However, the image processing accelerator 109 is not an essential element, and the CPU 111 can perform equivalent processing.

In the recording apparatus 108, pigment inks of four colors of C, M, Y, and K are used. The ejection amount of each nozzle in a recording head 115 functioning as a printing unit is set to 4 [pl].

### <Image Processing Flow>

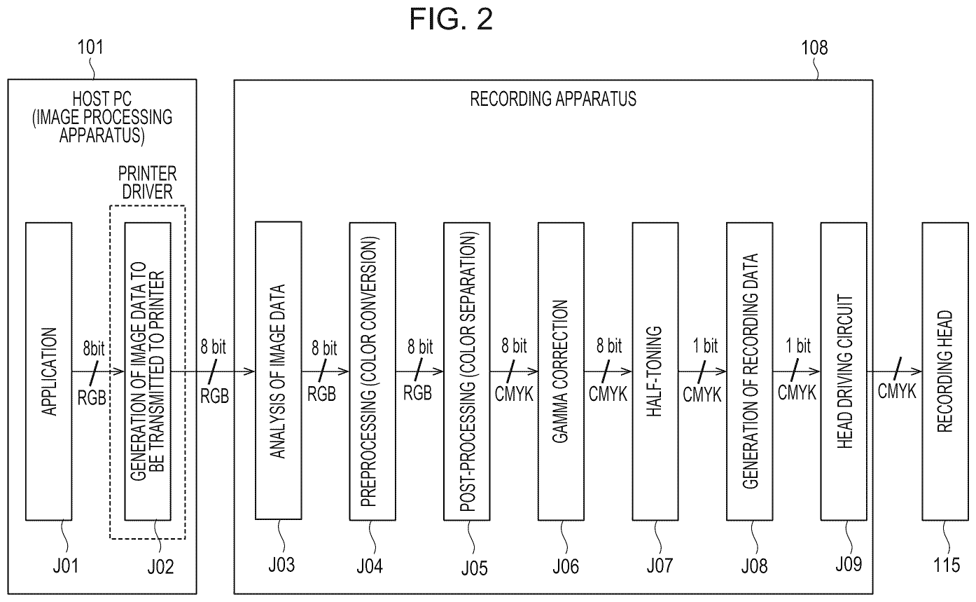

FIG. 2 is a block diagram illustrating the flow of image data conversion processing in a printing system according to a first embodiment. The image data conversion processing of the recording apparatus 108 will be described below.

The recording apparatus 108 according to the present embodiment performs recording using inks of four colors of cyan, magenta, yellow, and black. The recording head 115 includes a nozzle row for ejecting these inks of four colors. As illustrated in FIG. 2, each piece of image processing in the printing system is performed by a personal computer (PC) functioning as the image processing apparatus 101 and the recording apparatus 108.

Examples of a program operating in the operating system of the image processing apparatus 101 include applications and a printer driver. Examples of the application include applications for document creation and illustration.

In application processing J01, processing for generating image data corresponding to an image to be recorded (printed) by the recording apparatus 108 is performed by an application. The image data generated in the application processing J01 is transmitted to a printer driver. The printer driver for the image processing apparatus 101 generates image data in the page-description language (PDL) format as the image data. The image data in the PDL format is hereinafter referred to as PDL data. As an example of PDL, “PDF” by Adobe is known. PDL is widely used as an image format with which not only a bit map but also vector data such as lines and characters can be described.

The printer driver performs processing J02 for generating, from the image data transmitted from the application, image data to be transmitted to a printer. The image data to be transmitted to a printer is PDL data. The printer driver adds a header part including print setting information set via a user interface (UI) of the image processing apparatus 101 to generate the image data to be transmitted to a printer. The generated image data to be transmitted to a printer is transmitted from a data transfer I/F 107 in the image processing apparatus 101 to the recording apparatus 108 via a data transfer I/F unit 110 in the recording apparatus 108 and is stored in a data buffer (not illustrated). Such image data in the PDL format is transmitted from the image processing apparatus 101 to the recording apparatus 108.

The CPU 111 (an image processing unit) in the recording apparatus 108 performs image data analysis processing J03.

In the image data analysis processing J03, the image data in the PDL format is sequentially read out from the data buffer. The CPU 111 interprets a drawing command included in the PDL data and develops the PDL data into raster image data in a form similar to bitmap. The raster image data that has been subjected to the development is stored in the data buffer. The CPU 111 performs image processing upon the raster image data that has been subjected to the analysis and the development.

The CPU 111 performs color conversion processing J04 (preprocessing) for performing color matching between models, color separation processing J05 (post-processing), gamma correction processing J06, half-toning processing J07 that is binary quantization, and recording data generation processing J08. In the following, each piece of processing will be briefly described.

In the color separation processing J05, color separation processing is performed for converting 8-bit RGB data obtained in the preprocessing J04 into color separation data (8-bit CMYK data in this case) corresponding to combinations of inks that reproduce colors represented by the RGB data. Specifically, a conversion table (for example, three-dimensional (3D) lookup table (LUT)) is used in which the RGB data and the CMYK data corresponding to the inks are associated with each other in a one-to-one manner. The RGB data is converted into the CMYK data by referring to this conversion table. For example, in the 3D LUT, the values of R, G, and B, each represented by eight bits (0 to 255), and the values of C, M, Y, and K, each represented by eight bits (0 to 255), are associated with each other in advance. Then, conversion from (R, G, B)=(0 to 255, 0 to 255, 0 to 255) into (C, M, Y, K)=(0 to 255, 0 to 255, 0 to 255, 0 to 255) is performed.

For example,
in the case where (R, G, B)=(0, 0, 0),
this is converted into (C, M, Y, K)=(0, 0, 0, 255).
In the case where (R, G, B)=(255, 255, 255),
this is converted into (C, M, Y, K)=(0, 0, 0, 0).
In the case where (R, G, B)=(0, 128, 0),
this is converted into (C, M, Y, K)=(128, 0, 128, 0).

In the present embodiment, two types of 3D LUTs are provided. The conversion table used is switched according to predetermined conditions. This will be described in detail below.

In the gamma correction processing J06, tone value conversion is performed upon each piece of ink color data of the color separation data obtained in the color separation processing J05. Specifically, by using a one-dimensional LUT in accordance with the tone characteristics of each color ink of the recording apparatus 108, conversion is performed by which the color separation data is linearly associated with the tone characteristics of the recording apparatus 108.

In the half-toning processing J07, quantization processing is performed for converting each of the pieces of 8-bit color separation data C, M, Y, and K into 1-bit data. In the present embodiment, processing is performed for converting the 8-bit data of 256 tones into 1-bit data of two tones by using the binary dither method. In the recording data generation processing J08, recording data is generated by adding recording control information to recording image data including 1-bit dot data. The generated recording data is stored in a recording buffer (not illustrated). The binary recording data stored in the recording buffer is sequentially read by the CPU 111, input to a head driving circuit, and is subjected to driving processing J09. In the driving processing J09, 1-bit data of each color input to the head driving circuit is converted into a driving pulse of the recording head 115, and an ink is ejected at a predetermined timing.

### <Details of Printing Apparatus>

A printing apparatus according to the present embodiment will be described in more detail below.

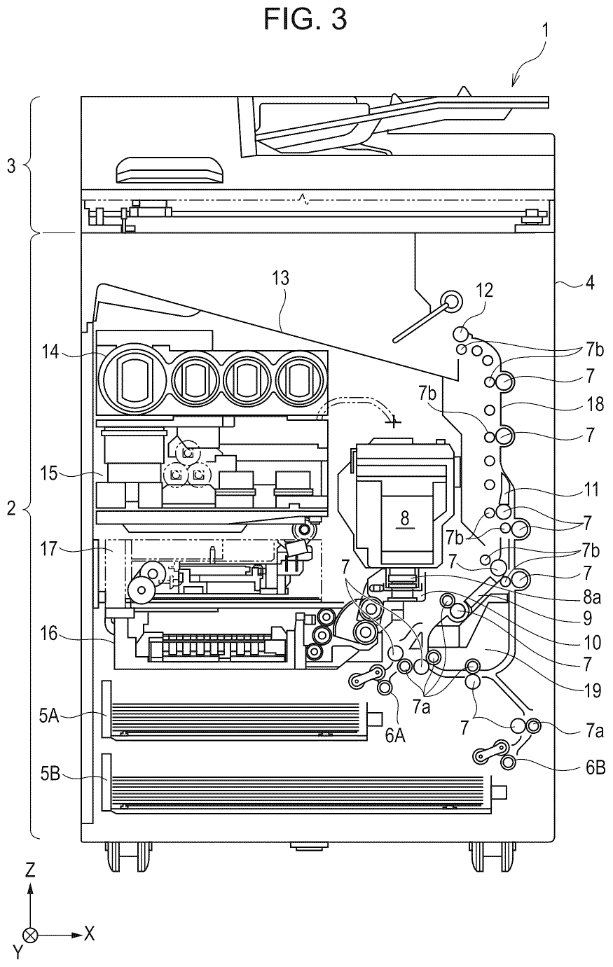

A recording apparatus 1 illustrated in FIG. 3 that is an example of the recording apparatus 108 is a multifunction machine including a printing unit 2 and a scanner unit 3. The recording apparatus 1 can use the printing unit 2 and the scanner unit 3 separately or in synchronization to perform various pieces of processing related to a recording operation and a reading operation. The scanner unit 3 includes an automatic document feeder (ADF) and a flat bed scanner (FBS). Accordingly, the scanner unit 3 can read a document automatically fed by the ADF and a document placed by a user on a platen glass of the FBS. Although the multifunction machine including the printing unit 2 and the scanner unit 3 is used in the present embodiment, the scanner unit 3 does not necessarily have to be provided.

FIG. 3 illustrates the recording apparatus 1 in a standby state in which it is performing neither the recording operation nor the reading operation.

In the printing unit 2, a first cassette 5A and a second cassette 5B for housing a recording medium (cut sheet) S are detachably disposed at the bottom of a casing 4 in the vertical direction. A relatively small recording medium of up to the A4 size is housed flat in the first cassette 5A, and a relatively large recording medium of up to the A3 size is housed flat in the second cassette 5B. A first feeding unit 6A for separately feeding housed recording media one by one is provided near the first cassette 5A. Similarly, a second feeding unit 6B is provided near the second cassette 5B.

When the recording operation is performed, the recording medium S is selectively fed from either one of the cassettes. Conveying rollers 7, a discharge roller 12, pinch rollers 7a, spurs 7b, a guide 18, an inner guide 19, and a flapper 11 are conveying mechanisms for guiding the recording medium S in a predetermined direction. The conveying rollers 7 are driving rollers located upstream and downstream of a recording head 8 (a platen 9) and driven by a conveying motor. The pinch rollers 7a are follower rollers that are turned while nipping the recording medium S along with the conveying rollers 7. The discharge roller 12 is a driving roller located downstream of the conveying rollers 7 and is driven by a discharge motor. The spurs 7b nip and convey the recording medium S along with the conveying rollers 7 and the discharge roller 12 located downstream of the recording head 8 (the platen 9). The guide 18 is provided in a conveying path of the recording medium S to guide the recording medium S in a predetermined direction. The inner guide 19 is a member extending in the y direction, has a curved side surface, and guides the recording medium along the side surface. The flapper 11 is a member for changing a direction in which the recording medium S is conveyed in a duplex recording operation.

A sheet discharge tray 13 included in the sheet discharge unit is a tray for stacking the recording media S that have been subjected to the recording operation and have been discharged by the discharge roller 12.

The recording head 8 in the present embodiment is a full-line type color inkjet recording head. In the recording head 8, a plurality of ejection openings for ejecting inks based on recording data are arrayed in the y direction in FIG. 3 to correspond to the width of the recording medium S. When the recording head 8 is in a standby position, an ejection opening surface 8a of the recording head 8 is oriented vertically downward and is capped with a cap unit 10 as illustrated in FIG. 3. When the recording operation is performed, the orientation of the recording head 8 is changed by a recording head controller 114 to be described below such that the ejection opening surface 8a faces the platen 9.

The platen 9 includes a flat plate extending in the y direction and supports, from the back side, the recording medium S to be subjected to the recording operation by the recording head 8.

An ink tank unit 14 separately stores inks of four colors to be supplied to the recording head 8. An ink supply unit 15 is provided in the midstream of a flow path connecting the ink tank unit 14 and the recording head 8 to adjust the pressure and flow rate of inks in the recording head 8 within a suitable range. The present embodiment adopts a circulation-type ink supply system, where the ink supply unit 15 adjusts the pressure of inks supplied to the recording head 8 and the flow rate of inks collected from the recording head 8 within a suitable range. A maintenance unit 16 includes the cap unit 10 and a wiping unit 17 and activates them at predetermined timings to perform a maintenance operation for the recording head 8.

### <Post-Processing Mechanism>

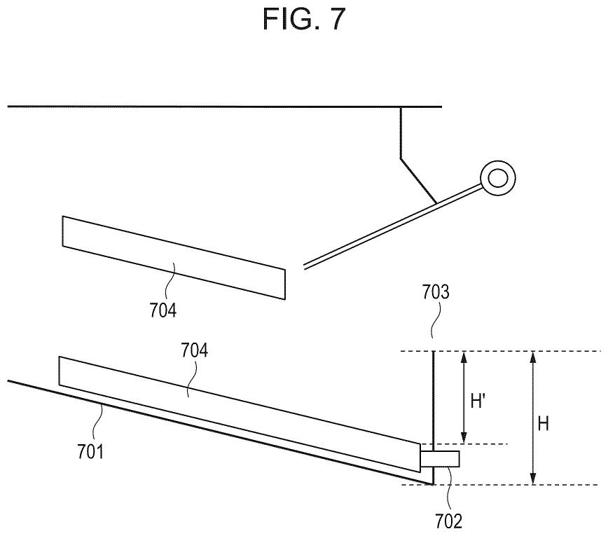

The post-processing mechanism can be attached to the sheet discharge unit in the printing apparatus. The post-processing function can therefore be used without increasing a footprint. FIG. 7 is a diagram illustrating the sheet discharge unit excerpted from FIG. 3 to which a post-processing mechanism 704 is attached. The post-processing mechanism 704 is attached along a sheet discharge tray 701. A sensor 702 can determine whether the post-processing mechanism 704 is attached.

The post-processing mechanism will be described. The post-processing mechanism has a shift sort function, a punching function for performing punching processing, and a stapling function. Each of these functions will be briefly described. The shift sort function is a mechanism for shifting a paper bundle by number of copies such that the paper bundle can be separated by number of copies after finishing. As will be described in detail below, after printing, moisture is applied to the printing surface side of a medium, hydrogen bonds in the medium are cleaved, and the medium is swollen. As a result of this, the medium warps such that the printing surface side is convex. A subsequent medium is discharged relative to a preceding medium on a sheet discharge tray that has warped after being discharged.

In the case where sorting is not set, media do not collide with each other and paper jams do not occur because left and right sheet discharge positions are aligned. However, when shift sorting is set, a subsequent medium rushes against, at a shifted position, a preceding medium that has warped into a downward convex after being discharged and these media collide with each other. This collision makes jams more likely to occur.

The stapling function is a function of automatically performing stapling. When stapled materials for, for example, meetings and proposals need to be prepared, the time required for the preparation can be markedly reduced. When the stapling function is used, a higher degree of alignment is required because a bundle misalignment is fixed as it is and leads to a bad appearance. Media need to be inserted into a narrower opening of a stapler. Accordingly, a jam is more likely to occur even when a curl amount is smaller.

The punching function is a function of punching holes in a printed sheet. Typically, the punched holes are used for bundling and filing with, for example, rings. When the amount of misalignment is large, the alignment after filing is poor. A higher degree of alignment is therefore required. Media need to be inserted into a narrower opening of a punch. Accordingly, a jam is more likely to occur even when a curl amount is smaller.

### <Print Setting>

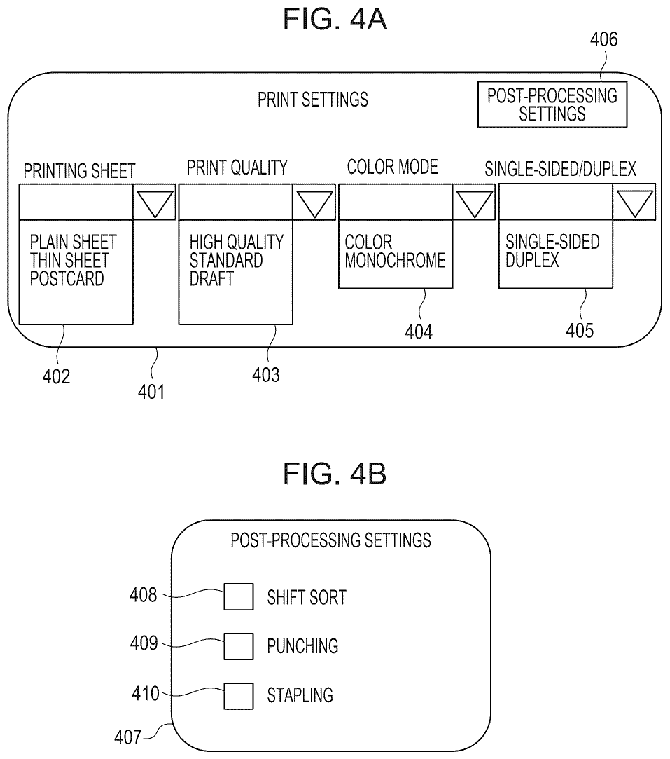

As illustrated in FIG. 4A, a user can perform a selection in the following multiple print modes through a print setting UI 401 for making a print instruction for a printer. Examples of the print mode include a printing sheet type selection 402, a print quality setting 403, a color mode 404, and a single-sided/duplex setting 405. Examples of a printing sheet include a plain sheet, a thin sheet, and a postcard. Examples of print quality include a high quality, a standard, and a draft that differ from each other in print quality and print speed. Examples of a color mode include a color print and a monochrome print. In the single-sided/duplex setting, a single-sided print or a duplex print can be specified.

### <Post-Processing Setting>

As illustrated in FIG. 4A, the print setting UI 401 includes a post-processing setting button 406 as a UI image for making a print instruction for a printer. This setting can be selected only when the post-processing mechanism has been determined to be attached by the sensor 702. Specifically, when the post-processing mechanism has not been determined to be attached, the post-processing setting button 406 is not displayed and cannot be selected. Alternatively, the post-processing setting button 406 may be grayed out such that it cannot be selected.

When the post-processing setting button 406 is selected, a post-processing setting UI 407 illustrated in FIG. 4B is displayed. The displayed UI includes a shift sort check box 408, a punching function check box 409, and a stapling function check box 410. A user selects a desired post-processing step, and the post-processing mechanism performs desired processing in response to an instruction. Although the case has been described above in which the image processing apparatus 101 performs the pieces of setting processing illustrated in FIGS. 4A and 4B, the recording apparatus 108 may perform the pieces of setting processing. In that case, settings are performed via a panel input unit connected to the recording apparatus 108.

### <Curl Generation Principle>

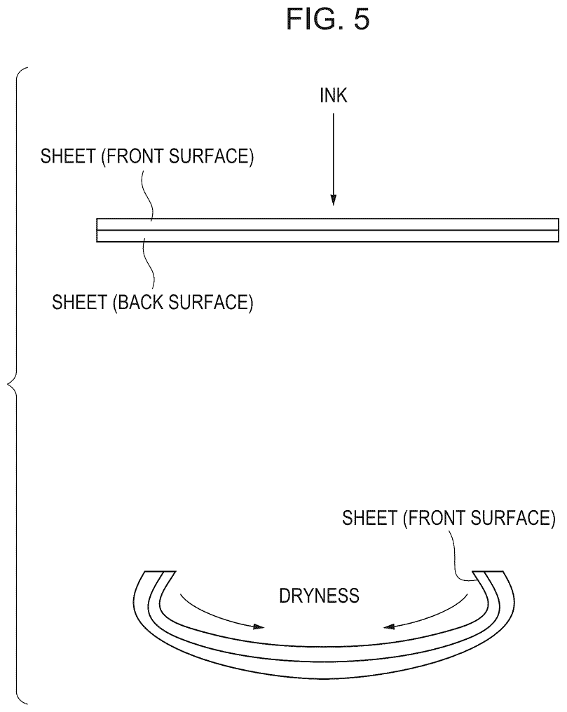

FIG. 5 is a diagram illustrating the curl of a recording medium at the time of single-sided printing. Aqueous inks are often used in inkjet printers. Accordingly, when an image is printed on only one side of a sheet, moisture (a solvent component of an ink) penetrates into the fibers of the sheet and the front surface side of the sheet swells first. As a result, a curl is generated such that the front surface side is raised. Subsequently, the moisture that has penetrated into the interior of the fibers of the sheet evaporates, and the front surface side shrinks more than before printing. As a result, the sheet curls such that a printed surface is inside as illustrated in FIG. 5.

The mechanism of curl generation will be further described in detail. When moisture is applied to a sheet, hydrogen bonds formed between cellulose fibers of the sheet are cleaved once. That is, the application of moisture causes the swelling of cellulose and a chemical phenomenon. At that time, ink penetration is not uniform in the direction of a sheet depth. The deeper the part of the sheet, the smaller the amount of ink present. Since the part that has been soaked in an ink, i.e., the fibers that have come into contact with water, swell, the sheet warps and curls towards the side opposite to the side to which moisture has been applied. That is, a minus curl occurs.

However, the moisture in cellulose that has been absorbed gradually evaporates. As the cellulose begins to shrink, the hydrogen bonds that have been cleaved are formed again. At that time, the hydrogen bonds are not formed again at the point where they have been cleaved but a different point. Accordingly, the sheet gradually warps and curls in the direction of the surface to which the moisture has been applied.

That is, a plus curl occurs.

A state in which a back surface warps toward a front surface side and becomes concave on the front surface side is called a plus curl, and a state in which a front surface warps toward a back surface side and becomes convex on the front surface side is called a minus curl. The plus curl is particularly problematic when inkjet recording is performed on, for example, a plain sheet. The plus curl may cause the misalignment of discharged recording media and a paper jam.

### <Curl and Jam>

The phenomenon that causes a paper jam in the process of discharging a curled recording medium will be described in detail.

In inkjet recording, the amount of curl generated on a recording medium varies depending on the recording duty of an image or an ink ejection amount (ink application amount). In particular, when an ink application amount is large, the curl of a recording medium that occurs after recording tends to become larger. A curl similarly becomes larger at low temperatures and low humidity.

When a recording medium is continued to be conveyed with a large curl and discharged to the sheet discharge tray of the recording apparatus, the curl of the recording medium becomes larger because the curl is released from the state in which the curl has been regulated in the conveying path. Alternatively, when a recording medium is discharged to the sheet discharge tray in the unstable state of a curl of the recording medium, the recording medium may be greatly deformed afterwards.

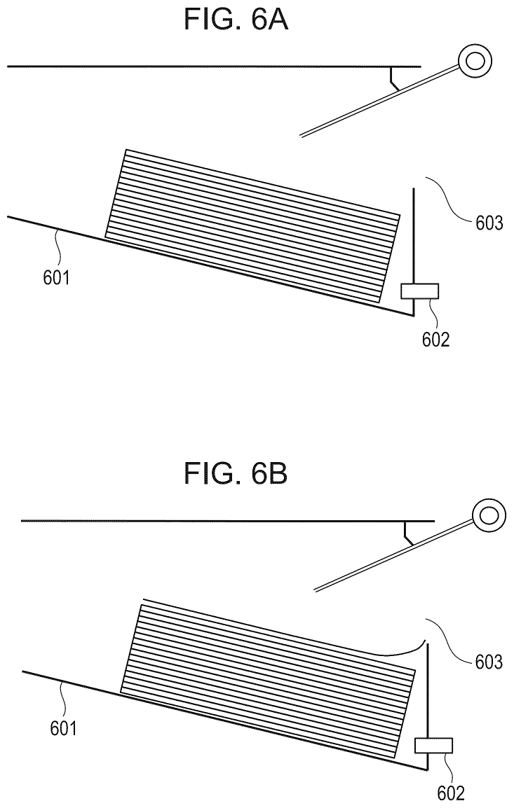

FIG. 6A is a diagram illustrating the state of a recording medium discharged to the sheet discharge tray. FIG. 6B is a schematic diagram illustrating the state in which a subsequent recording medium is discharged when a recording medium placed on the sheet discharge tray first remains curled and raised.

In FIG. 6A, a subsequent recording medium discharged from a sheet discharge port 603 does not come into contact with the recording medium placed on the sheet discharge tray.

As is apparent from FIG. 6B, a contact occurs when the subsequent recording medium discharged from the sheet discharge port 603 rushes against the preceding recording medium placed on the sheet discharge tray that remains curled and raised. As a result, the subsequent recording medium is pushed upward and deformed, and a paper jam therefore occurs.

When the curl of the preceding recording medium decreases with time and the height of the curl becomes lower than the position where the subsequent recording medium is to be discharged, a paper jam does not occur because the subsequent recording medium is discharged without coming into contact with the preceding recording medium.

### <Post-processing Mechanism and Paper Jam>

A paper jam when the post-processing mechanism is present will be described with reference to FIG. 7. H represents the height from a sheet discharge port 703 to the sheet discharge tray 701 before the post-processing mechanism 704 is attached. H′ represents the height from the sheet discharge port 703 to the sheet discharge position of the post-processing mechanism 704 after the post-processing mechanism 704 has been attached. As is apparent from FIG. 7, the stacking height of the sheet discharge unit becomes lower and sheet discharge space becomes narrower when the post-processing mechanism 704 is attached. A curl occurs as a result of printing as described above. When the post-processing mechanism 704 is attached, the stacking height becomes lower. Accordingly, a curl amount needs to be reduced as compared with the case where the post-processing mechanism 704 is not attached such that a paper jam is less likely to occur.

### <Ejection Amount and Curl>

As the amount of moisture applied per unit area of a sheet surface increases, the depth of moisture penetration into the sheet surface also increases. The degree of a curl becomes higher in proportion an ink ejection amount, because hydrogen bonds are cleaved in the depth direction of the sheet surface and more fibers lead to the curl. The relationship between an ink ejection amount and a curl amount will be described in detail below.

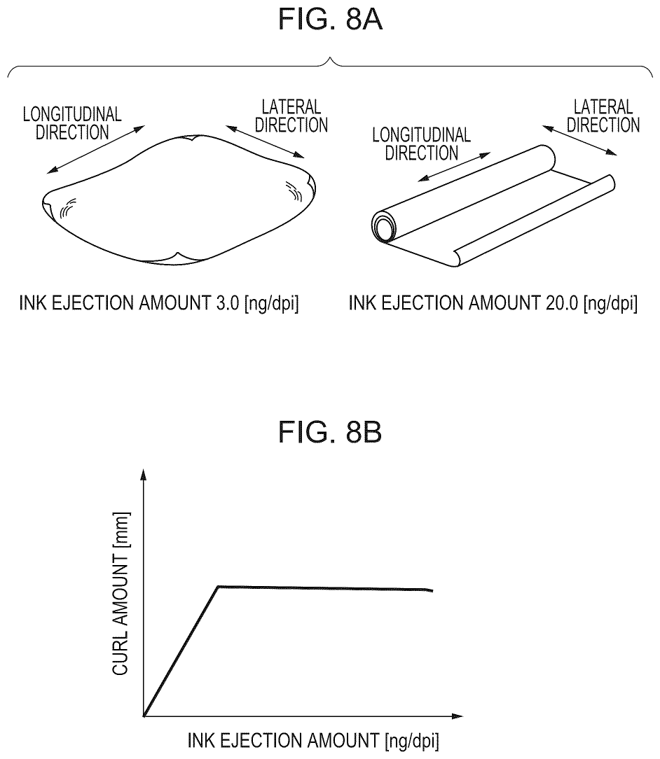

FIG. 8A is a diagram illustrating the direction in which a sheet is more likely to curl. As described above, paper has a fiber direction (paper grain), and the sheet used in the present embodiment is assumed to have a fiber flow along the longitudinal direction. In this case, the sheet is more likely to curl in the lateral direction. In particular, when the ink ejection amount is small (3.0 ng/dpi), the state of occurrence of a curl in the longitudinal direction and the state of occurrence of a curl in the lateral direction are almost the same. However, when the ink ejection amount is large (20.0 ng/dpi), a curl in the longitudinal direction is more likely to occur than a curl in the lateral direction.

FIG. 8B is a diagram illustrating a result of investigating the relationship between the ink ejection amount and the amount of an initial curl (curl) generated by the following method. An inkjet printer was used to perform solid printing on a plain sheet with a constant amount of ink, and a curl amount was measured immediately after the paper was discharged from the printer. The measurement of a curl amount was performed in such a manner that the time when printing was finished was set to 0, a printing surface was placed face down after a sheet was discharged, the maximum height (H) of the edge of the sheet that warped upward (back curl) was measured at four points, and the average value of the maximum heights was obtained and evaluated.

As is apparent from the drawing, the curl amount increases with the increase in the ink ejection amount in a region where the ink ejection amount is small.

The reason for this behavior is that the occurrence of a curl is determined by the difference in sheet elongation (tensile) between the front and the back, and the sheet elongation is large and a curl is large while the ink ejection amount is small.

When the ink ejection amount exceeds a certain amount, the amount of moisture that penetrates into the interior of the sheet increases, the difference in sheet elongation (tensile) between the front and the back becomes therefore small, and the curl does not change.

### <Printing Speed and Curl>

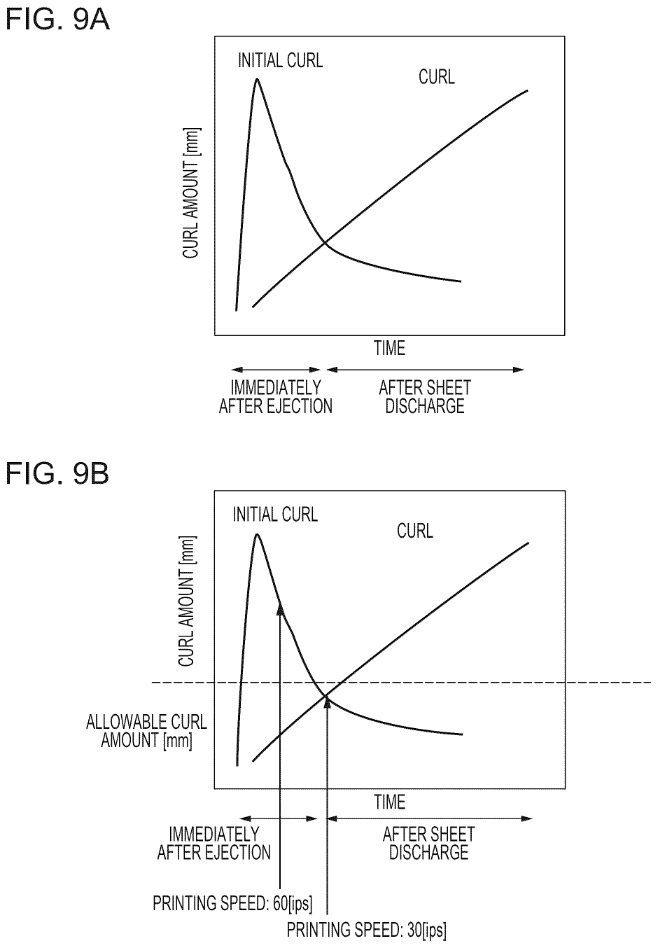

FIG. 9A is a diagram illustrating the relationship between the elapsed time after printing and the curl amount. The horizontal axis schematically represents the time elapsed since an ink has been applied, and the vertical axis schematically represents the curl amount. The measurement of the curl amount was performed in the same manner as the method described above, by performing solid printing on a plain sheet with a constant amount of ink and measuring the amount of change from the time immediately after the paper was discharged from the printer.

As illustrated in the drawing, the amount of an initial curl is large immediately after an ink has been applied and decreases with time. On the other hand, the final curl amount tends to increase with time. The reason for this curl behavior is that immediately after printing, the front surface side of a sheet swells and therefore curls in a raised manner. Subsequently, the moisture that has penetrated into the interior of the sheet evaporates, the front surface side shrinks more than before printing, and the sheet curls such that a printed surface is inside.

Based on this behavior, a paper jam caused by a contact between a preceding recording medium and a subsequent recording medium can be suppressed by delaying a sheet discharge until the maximum value of the initial curl amount of the preceding recording medium is below a position corresponding to the height of the sheet discharge port of the sheet discharge tray in the recording apparatus.

In addition to the relationship in FIG. 9A, FIG. 9B illustrates the curl amount that occurs when printing is performed at printing speeds corresponding to a standard mode and a draft mode in the present embodiment. The printing speed is slower in the standard mode than in the draft mode. In the standard mode, the initial curl amount exceeds an allowable curl amount.

For example, when printing is continued in the standard mode without changing the printing speed, the subsequent recording medium comes into contact with the preceding recording medium depending on the ink ejection amount of a print sample and a paper jam occurs.

The curl of the preceding recording medium decreases with time. When the height of the curl becomes lower than the position where the subsequent recording medium is to be discharged, a paper jam does not occur because the subsequent recording medium is discharged without coming into contact with the preceding recording medium. That is, the time from the start of printing to the discharge of a sheet can be increased by reducing a printing speed, and the curl amount after the discharge can be reduced.

Accordingly, it is desired that the printing speed be set based on the above-described relationship between the printing speed and the curl amount.

### <Printing Operation at the Time of Attachment of Post-Processing Mechanism>

Based on the above, curl reduction according to the present embodiment will be described.

As described above, when the post-processing mechanism is attached, a paper jam is more likely to occur because the sheet discharge port becomes narrower. Accordingly, it is necessary to reduce the curl amount after printing when the post-processing mechanism is attached as compared with the curl amount after printing before the post-processing mechanism is attached.

Examples of a method of reducing the curl amount include the above-described method of reducing a printing speed. For example, the wait time during printing and a carriage scanning speed can be adjusted or the number of print passes can be increased.

The printing time when printing is performed without the attachment of the post-processing mechanism will be considered. It is assumed that, when the print quality 403 is set to the standard mode (a first mode) in print settings from the print setting UI illustrated in FIG. 4A, printing is performed in a printing time t (seconds). It is also assumed that, in the case of a mode which is different from the standard mode and in which a relatively small amount of ink is used to print the same print target image as in the standard mode, e.g., the draft mode (a second mode), printing is performed in a printing time of s (seconds).

Next, the printing time when printing is performed after the attachment of the post-processing mechanism will be considered. It is assumed that, when the print quality 403 is set to the standard mode in the print settings from the print setting UI, printing is performed in a printing time t′ (seconds).

The relationship between the printing times is t′>t>s (seconds). Since it is necessary to reduce the curl amount after printing when the post-processing mechanism is attached as compared with the curl amount after printing before the post-processing mechanism is attached, t′ has the longest printing time.

As described above, when the amount of ink used during printing is small, the curl amount is also small and a paper jam is less likely to occur. Modes in which the amount of ink used is smaller than that in the standard mode are, for example, the draft mode and an eco mode, which are layout check modes in which printing is performed with a smaller amount of ink to save ink consumption. As described above, the monochrome mode is also a mode in which the amount of ink used is small.

In these modes in which the amount of ink used is small, the curl amount is small and there is therefore no need to reduce the speed even when the post-processing mechanism is attached. Alternatively, the degree of reducing a speed (the degree of speed reduction) may be controlled to be small. That is, by changing the degree of reducing a speed based on the print mode before and after the attachment of the post-processing mechanism, the reduction in printing productivity can be suppressed.

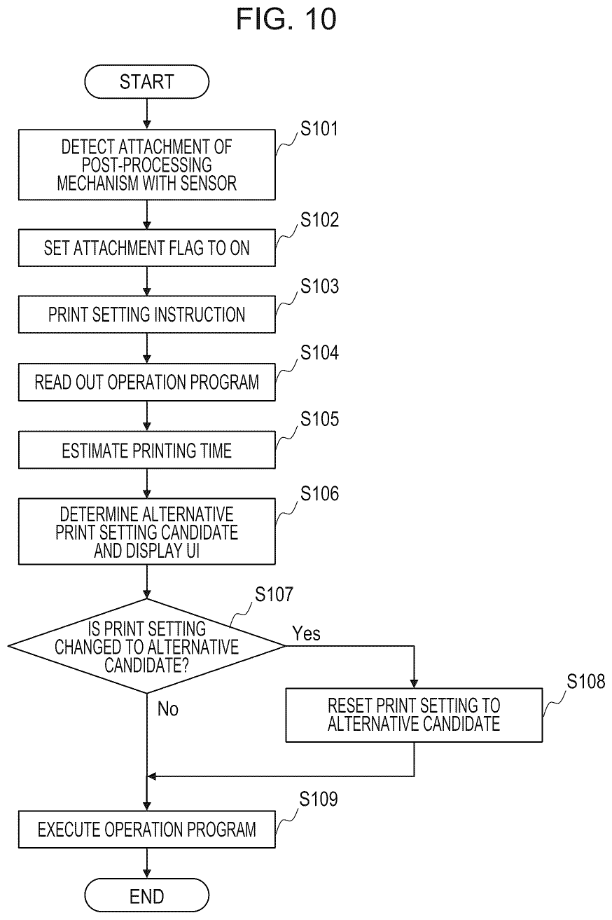

Based on the above, the operation of the printing apparatus (the recording apparatus 108) when the post-processing mechanism is attached will be described with reference to FIG. 10. Each step is performed or controlled by the CPU 111. Each processing (step) in the flowchart is indicated by a sign beginning with S. Each step does not necessarily have to be performed or controlled by the recording apparatus 108, and may be performed or controlled by the CPU 102 in the image processing apparatus 101.

In S101, the sensor detects the attachment of the post-processing mechanism to the recording apparatus 108. As illustrated in FIG. 7, the sensor 702 detects the attachment of the post-processing mechanism at the time of the attachment.

In S102, in response to a signal received from the sensor 702 which indicates that the post-processing mechanism has been attached to the recording apparatus 108, a post-processing unit attachment flag is set to ON which is stored in the RAM 112 and indicates whether the post-processing mechanism is attached.

In S103, a print instruction regarding print settings by a user is input from the print setting UI 401.

In S104, in accordance with the print instruction input in S103, the print operation table in the ROM 113 is referred to and a corresponding printing operation program is read and is loaded into the RAM 103.

In S105, a printing time required in the case of the print setting corresponding to the print instruction in S103 is estimated. The estimation of the printing time is performed by reading out a printing time from the print operation table to be described below. The read printing time is compared between modes as will be described below.

### <Print Setting and Printing Time>

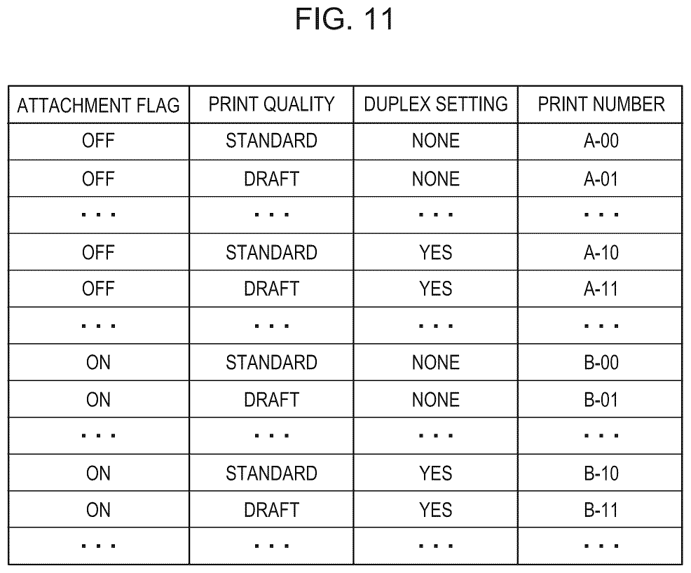

A print setting and a printing time will be described with reference to FIG. 11. The print operation table is as illustrated in FIG. 11. In the table, a printing operation number is set for each combination of print condition settings, such as the attachment or nonattachment of the post-processing mechanism and the print mode. Based on this printing operation number, a desired printing operation program is read out. Although the exemplary case has been described above where the table is used, the table may be provided in a different way as long as the correspondence between each combination of print condition settings and a printing operation is established.

The correspondence between the combination of print condition settings and a printing operation will be described using examples. In the case where the post-processing unit attachment flag is OFF, a print number A-00 is associated when the standard mode is selected and a print number A-01 is associated when the draft mode is selected. In the case where the post-processing unit attachment flag is ON, a print number B-00 is associated when the standard mode is selected and a print number B-01 is associated when the draft mode is selected.

The operation program is set such that a printing time is t (seconds) for A-00, a printing time is s (seconds) for A-01, a printing time is t′ (seconds) for B-00, and a printing time is s′ (seconds) for B-01. At this time, the relationship is t′ (seconds)>t (seconds)>s′ (seconds)=s (seconds), where t′ (seconds) is the longest time for a printing operation. The relationship may be s′ (seconds)>s (seconds), as long as the rate of increase of s′ (seconds) relative to s (seconds) is smaller than the rate of increase of t′ (seconds) relative to t (seconds). That is, the CPU 111 that is a control unit controls printing such that the decrease in printing speed after the attachment of the post-processing unit is smaller in the draft mode than in the standard mode.

With this relationship, even when the post-processing mechanism is attached, the increase in printing time can be prevented or suppressed in a print mode in which jam countermeasures are not required. Accordingly, the reduction in printing productivity can be suppressed.

The estimation of the printing time may be performed by reading out a printing time associated with a print number from the table as described above or by, for example, a simple expression. By the use of a simple expression, a capacity for the table can be reduced and a memory can be reduced.

The estimation of a printing time will be described using examples. The case will be described where the post-processing unit attachment flag is set to ON, the print quality is set to standard, and no duplex setting is set as the print instruction in S103. In this case, the print number is B-00 as illustrated in FIG. 11 and the estimated printing time is t′.

That is, as illustrated in the table in FIG. 11, the printing time may be shorter than t′ depending on the print setting. Accordingly, in such a case, a print setting candidate that enables the reduction in printing time in an obtained print mode is notified to a user through a UI in the present embodiment. By accepting a user instruction for that notification, the switching to a faster print setting can be achieved.

In S106, alternative candidates for print settings (hereinafter also referred to as alternative print setting candidates) are determined and presented to the user by displaying them through the UI. As illustrated in FIG. 11, the print setting that can be selected with the post-processing unit attachment flag ON is the print number B-01 indicating that the print quality is draft, no duplex setting is set, and the printing time is s′(seconds).

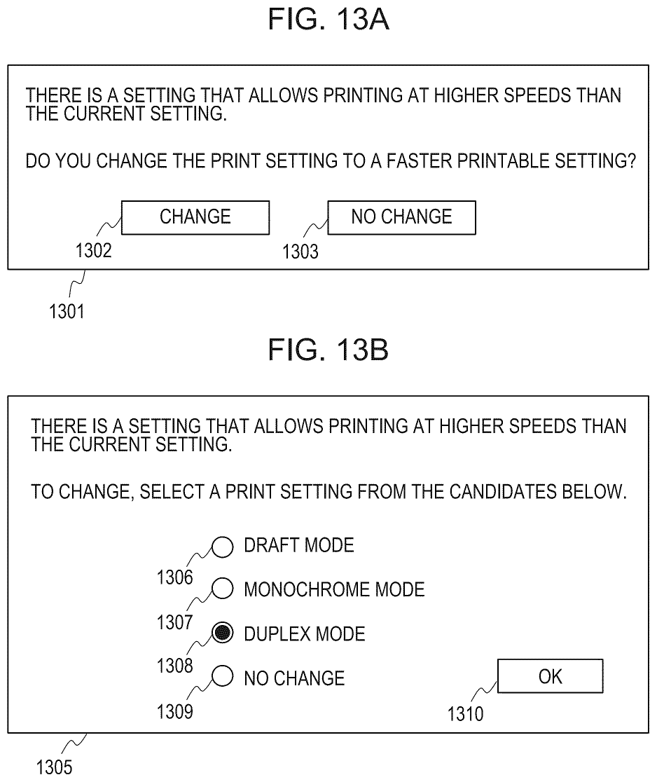

An image for presenting, as a UI, a UI screen 1301 that recommends changing to a fast print setting is illustrated in FIG. 13A. By displaying the UI screen 1301 and accepting the press of a change button 1302 by the user (S107), the print setting can be reset to the alternative print setting candidate (S108). In order to allow the user to check the print setting, the print setting UI 401 may be displayed in a state where the draft is selected as the print quality.

When a no change button 1303 is pressed after the UI screen 1301 has been displayed, the selection is made with which the change to an alternative candidate is not performed and the print setting in S104 is used.

Based on the print setting set above, the CPU 102 or 111 executes the operation program (S109).

Although the case has been described where the draft mode is a recommended setting for changing to a fast print setting in the above embodiment, the alternative print settings are not limited to the draft mode and include, for example, an eco mode and a monochrome mode. When printing the same print target image, high-speed printing is possible and could be an alternative print setting as long as a second mode is present in which the amount of ink used to print this print target image is smaller than that in a first mode and a curl is reduced.

In the printing time estimation in S105, the case has been described where the printing time estimation is performed using a table or an expression. However, this estimation processing itself can be skipped when the printing time difference is obvious without performing the processing. For example, in general, there is an obvious difference in printing speed between the standard mode and the draft mode in the print quality and the printing speed in the draft mode is faster. In this case, when the print quality is set to the standard mode, the draft mode having faster quality may be set as an alternative candidate without the estimation of the printing time.

In the first embodiment, the case has been described where the print mode with a small curl amount is the print mode with a small amount of ink used. In the present embodiment, the case will be described where duplex printing is used as the print mode with a small curl amount. After describing the relationship between duplex printing and a curl, an operation according to a second embodiment will be described below.

### <Duplex Printing and Curl>

As described above, when an image is printed on a sheet that is a print medium, moisture (a solvent component of an ink) penetrates into the fibers of the sheet and evaporates and the recording medium curls. This curl occurs not only in single-sided printing but also in duplex printing. However, in the case of duplex printing, the difference in the amount of ink ejected on the front and back surfaces affects the degree of curl. When the difference is large, the differences in swelling and shrinkage rates occur and the sheet curls.

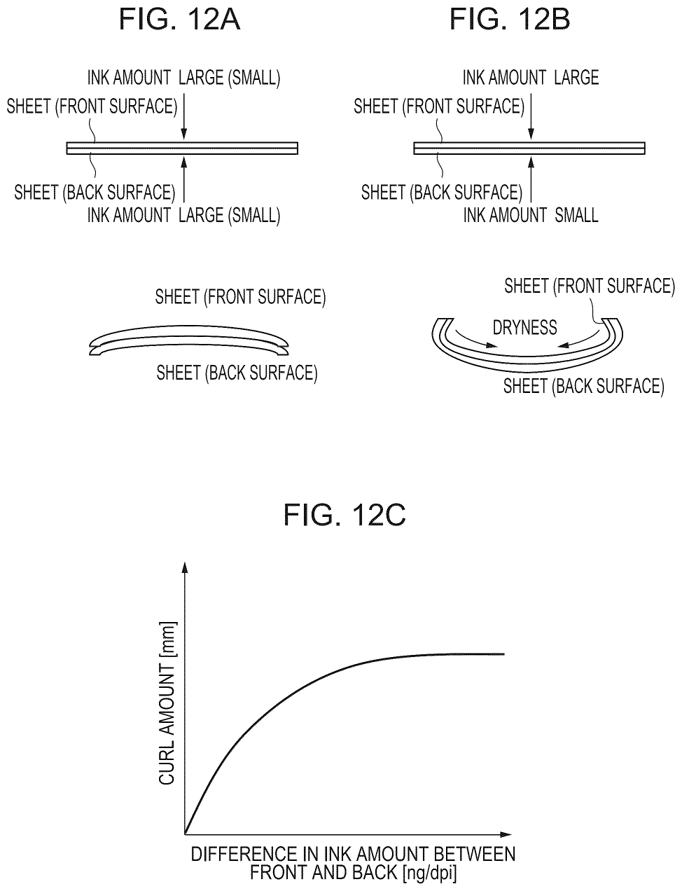

FIG. 12 is a diagram illustrating the curl of a recording medium at the time of duplex printing. FIG. 12A is a diagram illustrating a curl when the difference in ink amount between the front and back surfaces is small, and FIG. 12B is a diagram illustrating a curl when the difference in ink amount between the front and back surfaces is large. FIG. 12C is a schematic diagram illustrating the relationship between the difference in ink amount on the front and back surfaces and the curl amount.

As is apparent from the drawing, a curl occurs when the difference in ink amount between the front and back surfaces is large. That is, when the difference in ink amount between the front and back surfaces is small, a curl is less likely to occur. Since the amount of ink is present on both surfaces in duplex printing as compared with single-sided printing in which the amount of ink is present on only one of the surfaces, the difference in the amount of ink between the front and back surfaces is smaller in duplex printing than in single-sided printing. Accordingly, when duplex printing is set, a jam is less likely to occur because the curl amount is smaller than that in single-sided printing. There is therefore no need to reduce the speed as compared with the case single-sided printing is set.

### <Printing Operation at the Time of Attachment of Post-processing Mechanism>

A printing operation according to the present embodiment will be described. Descriptions will be made focusing on the points different from the first embodiment.

The correspondence between the combination of print condition settings including print condition settings for duplex printing and a printing operation will be described using the examples in FIG. 11. In the case where the post-processing unit attachment flag is OFF, the print number A-00 is associated when the standard mode is selected and a print number A-10 is associated when the setting of duplex printing (hereafter also referred to as a duplex setting) is selected even in the standard mode. In the case where the post-processing unit attachment flag is ON, the print number B-00 is associated when the standard mode is selected and a print number B-10 is associated when the duplex printing is selected even in the standard mode.

The operation program is set such that a printing time is t (seconds) for A-00, a printing time is u (seconds) for A-10, a printing time is t′ (seconds) for B-00, and a printing time is u′ (seconds) for B-10. At this time, the relationship is t′ (seconds)>t (seconds)>u′ (seconds)=u (seconds), where t′ (seconds) is the longest time for a printing operation. The relationship may be u′ (seconds)>u (seconds), as long as the rate of increase of u′ (seconds) relative to u (seconds) is smaller than the rate of increase of t′(seconds) relative to t (seconds).

With this relationship, even when the post-processing mechanism is attached, the increase in print time can be prevented or suppressed in a printing mode in which jam countermeasures are not required. Accordingly, the reduction in printing productivity can be suppressed.

The estimation of a printing time in S105 in the present embodiment will be described using an example. The case will be described where the post-processing unit attachment flag is set to ON, the print quality is set to standard, and no duplex setting is set as the print instruction in S103. In this case, the print number is B-00 as illustrated in FIG. 11 and the estimated printing time is t′. That is, the printing time may be shorter than t′ depending on the print setting.

In such a case, in the present embodiment, by presenting a printing setting with which the printing time can be shortened to a user through a UI and accepting a user instruction for that representation in S106, the switching to a faster print setting can be achieved. Specifically, alternative candidates for print settings (hereinafter also referred to as alternative print setting candidates) are determined and presented to the user by displaying them through the UI. As illustrated in FIG. 11, the print setting that can be selected with the post-processing unit attachment flag ON is the print number B-10 indicating that the print quality is standard, the duplex setting is set, and the printing time is u′ (seconds).

As a UI, the UI screen 1305 that recommends changing to a fast print setting is illustrated in FIG. 13B. The user can select an appropriate one from several print setting candidates on the displayed UI screen 1305. A draft mode 1306, a monochrome mode 1307, and a duplex mode 1308 are presented as selectable print setting candidates. The case is illustrated where a radio button for the duplex mode 1308 is selected. When the user presses an OK button 1310, the change is set (S107) and the print setting can be reset to the alternative print setting (S108). When the user does not want to make any changes, the user can select a “no change” radio button 1309. In that case, the print setting in S103 is used. Based on the print setting set above, the CPU 102 executes the operation program (S109).

With the alternative print setting candidates described above, high-speed printing can be achieved. However, the changes in image quality occur, such as a coarse draft-level resolution, a low density due to a small amount of ink, and the change from a color document to a monochrome document. Accordingly, a UI format is designed to allow the user to perform a selection using radio buttons with messages with which the user can imagine image quality or to select not to make any changes. The user can obtain an acceptable image quality level and high-speed printing at the level while understanding the change in image quality. Instead of the above messages, for example, icons may be used as long as they indicate that the change in image quality will occur.

Duplex printing has been described as a print mode in which the curl amount is small in the present embodiment, but the printing time may be set by combining duplex printing with the mode in the first embodiment in which the ejection amount is also small. Although the standard mode and the draft mode have been described as examples, a high-quality mode (the ejection amount is large) and the standard mode (the ejection amount is small) may be used as long as the ejection amounts are different in these modes. Furthermore, an operation program for a shorter printing time may be used when the under color remove (UCR) processing is turned on, from the viewpoint of reducing the ink ejection amount.

Although the above embodiments have been described using the serial head as an example, a line head may be used. In the case of a line head, the amount of ink applied to a sheet surface once becomes larger. Accordingly, the curl amount is also expected to become larger. According to the present embodiment, a larger effect can be obtained.

The present embodiments can also be realized by supplying a program that realizes one or more functions of the above embodiments to a system or an apparatus via a network or a storage medium and causing one or more processors in the computer of the system or apparatus to read out and execute the program. Furthermore, the present embodiments can also be realized by a circuit (e.g., application specific integrated circuit (ASIC)) that realizes one or more functions of the embodiments.

According to the present disclosure, an appropriate printing operation can be performed before and after the attachment of the post-processing mechanism while reducing paper jams.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-035275 filed Mar. 7, 2024, which is hereby incorporated by reference herein in its entirety.

What is claimed is:

1. An image processing apparatus to which a post-processing unit is attachable, a height from a position of a print medium discharged from a sheet discharge port to the sheet discharge port being reduced after the post-processing unit has been attached, the image processing apparatus comprising:
at least one memory that stores a set of instructions; and
at least one processor that executes the instructions causing the image processing apparatus to perform operations comprising:
an input unit configured to, after the post-processing unit has been attached, input an instruction for setting a first mode among a plurality of print modes for determining print conditions in printing a print target image; and
a generation unit configured to, when, after the post-processing unit has been attached, there is a second mode which is different from the first mode and in which an amount of ink used to print a same image is smaller than that in the first mode, generate a display image to indicate that the second mode can be selected as the print mode for the print target image.

2. The image processing apparatus according to claim 1, wherein the second mode is one of a plurality of second modes.

3. The image processing apparatus according to claim 2, wherein the generation unit generates a display image to accept an instruction for selecting the second mode.

4. The image processing apparatus according to claim 3, further comprising a printing unit,
wherein the printing unit prints the print target image in the second mode when the instruction is accepted.

5. The image processing apparatus according to claim 1, wherein the second mode can take a shorter time for printing than the first mode.

6. The image processing apparatus according to claim 1, wherein a display image generated by the generation unit includes details indicating that image quality will change from image quality obtained by printing in the first mode.

7. The image processing apparatus according to claim 1, wherein a display image generated by the generation unit includes an UI enabling a selection not to change from the first mode to the second mode.

8. The image processing apparatus according to claim 1, wherein the generation unit determines whether there is the second mode after the post-processing unit has been attached by estimating respective times required to print the print target image in the plurality of print modes and comparing the respective estimated times with a time required to print the print target image in the first mode.

9. A non-transitory computer-readable storage medium storing instructions that, when executed by a computer, cause the computer to perform an image processing method in an image processing apparatus to which a post-processing unit is attachable, a height from a position of a print medium discharged from a sheet discharge port to the sheet discharge port being reduced after the post-processing unit has been attached, the image processing method comprising:
inputting, after the post-processing unit has been attached, an instruction for setting a first mode among a plurality of print modes for determining print conditions in printing a print target image; and
generating, when, after the post-processing unit has been attached, there is a second mode which is different from the first mode and in which an amount of ink used to print a same image is smaller than that in the first mode, a display image to indicate that the second mode can be selected as the print mode for the print target image.

10. An image processing method in an image processing apparatus to which a post-processing unit is attachable, a height from a position of a print medium discharged from a sheet discharge port to the sheet discharge port being reduced after the post-processing unit has been attached, the image processing method comprising:
inputting, after the post-processing unit has been attached, an instruction for setting a first mode among a plurality of print modes for determining print conditions in printing a print target image; and
generating, when, after the post-processing unit has been attached, there is a second mode which is different from the first mode and in which an amount of ink used to print a same image is smaller than that in the first mode, a display image to indicate that the second mode can be selected as the print mode for the print target image.
